(19) United States
(12) Patent Application Publication
(10) Pub. No.: US 2023/0342324 A1
(43) Pub. Date: Oct. 26, 2023

(54) SMART NETWORK INTERFACE CONTROLLER SERIAL COMMUNICATION REDIRECTION

(71) Applicant: Dell Products L.P., Round Rock, TX (US)

(72) Inventors: Deepaganesh PAULRAJ, Bangalore (IN); Akkiah Choudary MADDUKURI, Austin, TX (US); Lee E. BALLARD, Georgetown, TX (US); Elie Antoun JREIJ, Pflugerville, TX (US); Mahesh Babu RAMAIAH, Bangalore (IN); Rajeshkumar Ichchhubhai PATEL, Bangalore (IN); Rama BISA, Bangalore (IN); Jitendra Kumar RATH, Bangalore (IN); Brian Scott BERRY, Round Rock, TX (US)

(73) Assignee: Dell Products L.P., Round Rock, TX (US)

(21) Appl. No.: 17/728,672

(22) Filed: Apr. 25, 2022

(51) Int. Cl. G06F 13/38; G06F 13/42

(52) U.S. Cl. CPC G06F 13/4282; G06F 13/382; G06F 2213/0042; G06F 2213/3808

(57) ABSTRACT

An information handling system may include a management controller configured to provide out-of-band management of the information handling system. The information handling system may further include a network interface controller. The management controller may be configured to: receive management data from the network interface controller; and redirect the management data to a remote console.

### TECHNICAL FIELD

The present disclosure relates in general to information handling systems, and more particularly to methods and systems for communicating with a smart network interface controller.

### BACKGROUND

As the value and use of information continues to increase, individuals and businesses seek additional ways to process and store information. One option available to users is information handling systems. An information handling system generally processes, compiles, stores, and/or communicates information or data for business, personal, or other purposes thereby allowing users to take advantage of the value of the information. Because technology and information handling needs and requirements vary between different users or applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific user or specific use such as financial transaction processing, airline reservations, enterprise data storage, or global communications. In addition, information handling systems may include a variety of hardware and software components that may be configured to process, store, and communicate information and may include one or more computer systems, data storage systems, and networking systems.

In some computing applications, an information handling system may include a hypervisor for hosting one or more virtual resources such as virtual machines (VMs). A hypervisor may comprise software and/or firmware generally operable to allow multiple virtual machines and/or operating systems to run on a single information handling system at the same time. This operability is generally allowed via virtualization, a technique for hiding the physical characteristics of computing system resources (e.g., physical hardware of the computing system) from the way in which other systems, applications, or end users interact with those resources. Thus, a virtual machine may comprise any program of executable instructions, or aggregation of programs of executable instructions, configured to execute a guest operating system on a hypervisor or host operating system in order to act through or in connection with the hypervisor/host operating system to manage and/or control the allocation and usage of hardware resources such as memory, central processing unit time, disk space, and input and output devices, and provide an interface between such hardware resources and application programs hosted by the guest operating system.

In other applications, an information handling system may be used in a “bare metal” configuration in which only one operating system is installed, and the hypervisor and virtual resources are not needed.

In either scenario, a network interface of the information handling system may comprise a smart network interface card or “SmartNIC” and/or a data processing unit (DPU), which may offer capabilities not found in traditional NICs. For purposes of this disclosure, the terms “SmartNIC” and “DPU” may be used interchangeably. Further, it should be noted that some embodiments may operate on devices other than SmartNICs. For example, graphics processing units (GPUs), infrastructure processing units (IPUs), and other types of accelerators and smart devices may benefit from the teachings of this disclosure. For the sake of clarity and concreteness, the SmartNIC example will be discussed in detail herein, but one of ordinary skill in the art with the benefit of this disclosure will understand its application to such other devices.

A SmartNIC may act as a system within a system, including its own Unified Extensible Firmware Interface Basic Input/Output System (UEFI BIOS), its own operating system (OS) such as ESXio or any other suitable OS, and/or its own management controller such as a baseboard management controller (BMC).

Some embodiments of this disclosure are related to the use of a remote virtual console that is used to redirect the keyboard, video, and mouse (KVM) of a SmartNIC to a host system using out-of-band management functionality of a management controller. Currently, there is no way of redirecting a console of a SmartNIC OS and/or pre-OS environment (e.g., a SmartNIC UEFI BIOS) using such out-of-band methods. Embodiments may enable such redirection, providing the ability to manage and debug one or more SmartNICs remotely without using SmartNIC resources.

Additional embodiments are related to the redirection of serial communication. In particular, some SmartNICs may lack the ability to use Intelligent Platform Management Interface (IPMI), and so currently there is no way to redirect the SmartNIC serial console traffic over an IPMI session. This limits the ability to provide asynchronous serial-based OS and pre-OS communication remotely. Thus embodiments may provide the ability to redirect serial traffic from one or more SmartNICs.

In various embodiments, either the KVM redirection or serial redirection functionality may be used, or they may be combined and used simultaneously.

It should be noted that the discussion of a technique in the Background section of this disclosure does not constitute an admission of prior-art status. No such admissions are made herein, unless clearly and unambiguously identified as such.

### SUMMARY

In accordance with the teachings of the present disclosure, the disadvantages and problems associated with redirecting SmartNIC communications may be reduced or eliminated.

In accordance with embodiments of the present disclosure, an information handling system may include a management controller configured to provide out-of-band management of the information handling system. The information handling system may further include a network interface controller. The management controller may be configured to: receive management data from the network interface controller; and redirect the management data to a remote console.

In accordance with these and other embodiments of the present disclosure, a method may include, in an information handling system including a network interface controller and a management controller configured to provide out-of-band management of the information handling system: the management controller receiving management data from the network interface controller; and the management controller redirecting the management data to a remote console.

In accordance with these and other embodiments of the present disclosure, an article of manufacture may include a non-transitory, computer-readable medium having instructions thereon that are executable by at least one processor of a management controller of an information handling system for: receiving management data from a network interface controller of the information handling system; and redirecting the management data to a remote console.

Technical advantages of the present disclosure may be readily apparent to one skilled in the art from the figures, description and claims included herein. The objects and advantages of the embodiments will be realized and achieved at least by the elements, features, and combinations particularly pointed out in the claims.

It is to be understood that both the foregoing general description and the following detailed description are examples and explanatory and are not restrictive of the claims set forth in this disclosure.

### BRIEF DESCRIPTION OF THE DRAWINGS

A more complete understanding of the present embodiments and advantages thereof may be acquired by referring to the following description taken in conjunction with the accompanying drawings, in which like reference numbers indicate like features, and wherein:

FIG. 1 illustrates a block diagram of selected components of an example information handling system, in accordance with embodiments of the present disclosure;

FIG. 2 illustrates a block diagram of selected components of an example information handling system configured for remote KVM access to a SmartNIC, in accordance with embodiments of the present disclosure;

FIG. 3 illustrates a block diagram of selected components of an example information handling system configured for remote KVM access to a plurality of SmartNICs, in accordance with embodiments of the present disclosure;

FIG. 4 illustrates a block diagram of selected components of an example information handling system configured for remote KVM access to a plurality of SmartNICs, in accordance with embodiments of the present disclosure;

FIG. 5 illustrates a block diagram of selected components of an example information handling system configured for remote KVM access to a plurality of SmartNICs, in accordance with embodiments of the present disclosure; and

FIG. 6 illustrates a block diagram of selected components of an example information handling system configured for remote serial console access to a plurality of SmartNICs, in accordance with embodiments of the present disclosure.

### DETAILED DESCRIPTION

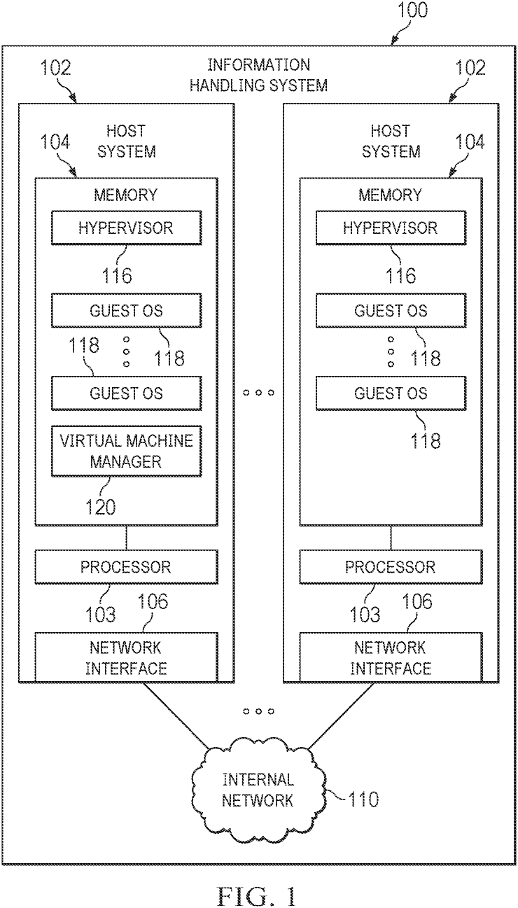

Preferred embodiments and their advantages are best understood by reference to FIGS. 1 through 6, wherein like numbers are used to indicate like and corresponding parts.

For the purposes of this disclosure, the term “information handling system” may include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, entertainment, or other purposes. For example, an information handling system may be a personal computer, a personal digital assistant (PDA), a consumer electronic device, a network storage device, or any other suitable device and may vary in size, shape, performance, functionality, and price. The information handling system may include memory, one or more processing resources such as a central processing unit (“CPU”) or hardware or software control logic. Additional components of the information handling system may include one or more storage devices, one or more communications ports for communicating with external devices as well as various input/output (“I/O”) devices, such as a keyboard, a mouse, and a video display. The information handling system may also include one or more buses operable to transmit communication between the various hardware components.

For purposes of this disclosure, when two or more elements are referred to as “coupled” to one another, such term indicates that such two or more elements are in electronic communication or mechanical communication, as applicable, whether connected directly or indirectly, with or without intervening elements.

When two or more elements are referred to as “coupleable” to one another, such term indicates that they are capable of being coupled together.

For the purposes of this disclosure, the term “computer-readable medium” (e.g., transitory or non-transitory computer-readable medium) may include any instrumentality or aggregation of instrumentalities that may retain data and/or instructions for a period of time. Computer-readable media may include, without limitation, storage media such as a direct access storage device (e.g., a hard disk drive or floppy disk), a sequential access storage device (e.g., a tape disk drive), compact disk, CD-ROM, DVD, random access memory (RAM), read-only memory (ROM), electrically erasable programmable read-only memory (EEPROM), and/or flash memory; communications media such as wires, optical fibers, microwaves, radio waves, and other electromagnetic and/or optical carriers; and/or any combination of the foregoing. Physical computer-readable media such as disk drives, solid-state drives, non-volatile memory, etc. may also be referred to herein as “physical storage resources.”

For the purposes of this disclosure, the term “information handling resource” may broadly refer to any component system, device, or apparatus of an information handling system, including without limitation processors, service processors, basic input/output systems, buses, memories, I/O devices and/or interfaces, storage resources, network interfaces, motherboards, and/or any other components and/or elements of an information handling system.

For the purposes of this disclosure, the term “management controller” may broadly refer to an information handling system that provides management functionality (typically out-of-band management functionality) to one or more other information handling systems. In some embodiments, a management controller may be (or may be an integral part of) a service processor, a baseboard management controller (BMC), a chassis management controller (CMC), or a remote access controller (e.g., a Dell Remote Access Controller (DRAC) or Integrated Dell Remote Access Controller (iDRAC)).

FIG. 1 illustrates a block diagram of selected components of an example information handling system 100 having a plurality of host systems 102, in accordance with embodiments of the present disclosure. As shown in FIG. 1, information handling system 100 may include a plurality of host systems 102 coupled to one another via an internal network 110.

In some embodiments, information handling system 100 may include a single chassis housing a plurality of host systems 102. In other embodiments, information handling system 100 may include a cluster of multiple chassis, each with one or more host systems 102. In yet other embodiments, host systems 102 may be entirely separate information handling systems, and they may be coupled together via an internal network or an external network such as the Internet.

In some embodiments, a host system 102 may comprise a server (e.g., embodied in a “sled” form factor). In these and other embodiments, a host system 102 may comprise a personal computer. In other embodiments, a host system 102 may be a portable computing device (e.g., a laptop, notebook, tablet, handheld, smart phone, personal digital assistant, etc.). As depicted in FIG. 1, information handling system 100 may include a processor 103, a memory 104 communicatively coupled to processor 103, and a network interface 106 communicatively coupled to processor 103. For the purposes of clarity and exposition, in FIG. 1, each host system 102 is shown as comprising only a single processor 103, single memory 104, and single network interface 106. However, a host system 102 may comprise any suitable number of processors 103, memories 104, and network interfaces 106.

A processor 103 may include any system, device, or apparatus configured to interpret and/or execute program instructions and/or process data, and may include, without limitation, a microprocessor, microcontroller, digital signal processor (DSP), application specific integrated circuit (ASIC), or any other digital or analog circuitry configured to interpret and/or execute program instructions and/or process data. In some embodiments, processor 103 may interpret and/or execute program instructions and/or process data stored in a memory 104 and/or other computer-readable media accessible to processor 103.

A memory 104 may be communicatively coupled to a processor 103 and may include any system, device, or apparatus configured to retain program instructions and/or data for a period of time (e.g., computer-readable media). A memory 104 may include RAM, EEPROM, a PCMCIA card, flash memory, magnetic storage, opto-magnetic storage, or any suitable selection and/or array of volatile or non-volatile memory that retains data after power to information handling system 100 is turned off.

As shown in FIG. 1, a memory 104 may have stored thereon a hypervisor 116 and one or more guest operating systems (OS) 118. In some embodiments, hypervisor 116 and one or more of guest OSes 118 may be stored in a computer-readable medium (e.g., a local or remote hard disk drive) other than a memory 104 which is accessible to processor 103. Each guest OS 118 may also be referred to as a “virtual machine.”

A hypervisor 116 may comprise software and/or firmware generally operable to allow multiple virtual machines and/or operating systems to run on a single computing system (e.g., an information handling system 100) at the same time. This operability is generally allowed via virtualization, a technique for hiding the physical characteristics of computing system resources (e.g., physical hardware of the computing system) from the way in which other systems, applications, or end users interact with those resources. A hypervisor 116 may be one of a variety of proprietary and/or commercially available virtualization platforms, including without limitation, VIRTUALLOGIX VLX FOR EMBEDDED SYSTEMS, IBM’s Z/VM, XEN, ORACLE VM, VMWARE’s ESX SERVER, L4 MICROKERNEL, TRANGO, MICROSOFT’s HYPER-V, SUN’s LOGICAL DOMAINS, HITACHI’s VIRTAGE, KVM, VMWARE SERVER, VMWARE WORKSTATION, VMWARE FUSION, QEMU, MICROSOFT’s VIRTUAL PC and VIRTUAL SERVER, INNOTEK’s VIRTUALBOX, and SWSOFT’s PARALLELS WORKSTATION and PARALLELS DESKTOP.

In one embodiment, a hypervisor 116 may comprise a specially-designed OS with native virtualization capabilities. In another embodiment, a hypervisor 116 may comprise a standard OS with an incorporated virtualization component for performing virtualization.

In another embodiment, a hypervisor 116 may comprise a standard OS running alongside a separate virtualization application. In this embodiment, the virtualization application of the hypervisor 116 may be an application running above the OS and interacting with computing system resources only through the OS. Alternatively, the virtualization application of a hypervisor 116 may, on some levels, interact indirectly with computing system resources via the OS, and, on other levels, interact directly with computing system resources (e.g., similar to the way the OS interacts directly with computing system resources, or as firmware running on computing system resources). As a further alternative, the virtualization application of a hypervisor 116 may, on all levels, interact directly with computing system resources (e.g., similar to the way the OS interacts directly with computing system resources, or as firmware running on computing system resources) without utilizing the OS, although still interacting with the OS to coordinate use of computing system resources.

As stated above, a hypervisor 116 may instantiate one or more virtual machines. A virtual machine may comprise any program of executable instructions, or aggregation of programs of executable instructions, configured to execute a guest OS 118 in order to act through or in connection with a hypervisor 116 to manage and/or control the allocation and usage of hardware resources such as memory, CPU time, disk space, and input and output devices, and provide an interface between such hardware resources and application programs hosted by the guest OS 118. In some embodiments, a guest OS 118 may be a general-purpose OS such as WINDOWS or LINUX, for example. In other embodiments, a guest OS 118 may comprise a specific- and/or limited-purpose OS, configured so as to perform application-specific functionality (e.g., persistent storage).

At least one host system 102 in information handling system 100 may have stored within its memory 104 a virtual machine manager 120. A virtual machine manager 120 may comprise software and/or firmware generally operable to manage individual hypervisors 116 and the guest OSes 118 instantiated on each hypervisor 116, including controlling migration of guest OSes 118 between hypervisors 116. Although FIG. 1 shows virtual machine manager 120 instantiated on a host system 102 on which a hypervisor 116 is also instantiated, in some embodiments virtual machine manager 120 may be instantiated on a dedicated host system 102 within information handling system 100, or a host system 102 of another information handling system 100.

A network interface 106 may include any suitable system, apparatus, or device operable to serve as an interface between an associated information handling system 100 and internal network 110. A network interface 106 may enable its associated information handling system 100 to communicate with internal network 110 using any suitable transmission protocol (e.g., TCP/IP) and/or standard (e.g., IEEE 802.11, Wi-Fi). In certain embodiments, a network interface 106 may include a physical network interface card (NIC). In the same or alternative embodiments, a network interface 106 may be configured to communicate via wireless transmissions. In the same or alternative embodiments, a network interface 106 may provide physical access to a networking medium and/or provide a low-level addressing system (e.g., through the use of Media Access Control addresses). In some embodiments, a network interface 106 may be implemented as a local area network (“LAN”) on motherboard (“LOM”) interface. A network interface 106 may comprise one or more suitable NICs, including without limitation, mezzanine cards, network daughter cards, etc.

In some embodiments, a network interface 106 may comprise a SmartNIC and/or a DPU. In addition to the stateful and custom offloads a SmartNIC or DPU may provide, it may have an independent management domain with a separate operating system, independent credentials, and independent remote access. Accordingly, network interface 106 may include its own specialized processor and memory.

In addition to processor 103, memory 104, and network interface 106, a host system 102 may include one or more other information handling resources.

Internal network 110 may be a network and/or fabric configured to communicatively couple information handling systems to each other. In certain embodiments, internal network 110 may include a communication infrastructure, which provides physical connections, and a management layer, which organizes the physical connections of host systems 102 and other devices coupled to internal network 110. Internal network 110 may be implemented as, or may be a part of, a storage area network (SAN), personal area network (PAN), local area network (LAN), a metropolitan area network (MAN), a wide area network (WAN), a wireless local area network (WLAN), a virtual private network (VPN), an intranet, the Internet or any other appropriate architecture or system that facilitates the communication of signals, data and/or messages (generally referred to as data). Internal network 110 may transmit data using any storage and/or communication protocol, including without limitation, Fibre Channel, Fibre Channel over Ethernet (FCoE), Small Computer System Interface (SCSI), Internet SCSI (iSCSI), Frame Relay, Ethernet Asynchronous Transfer Mode (ATM), Internet protocol (IP), or other packet-based protocol, and/or any combination thereof. Network 110 and its various components may be implemented using hardware, software, or any combination thereof.

As discussed above, embodiments of this disclosure may provide techniques for redirecting communications to and/or from one or more SmartNICs such as network interfaces 106.

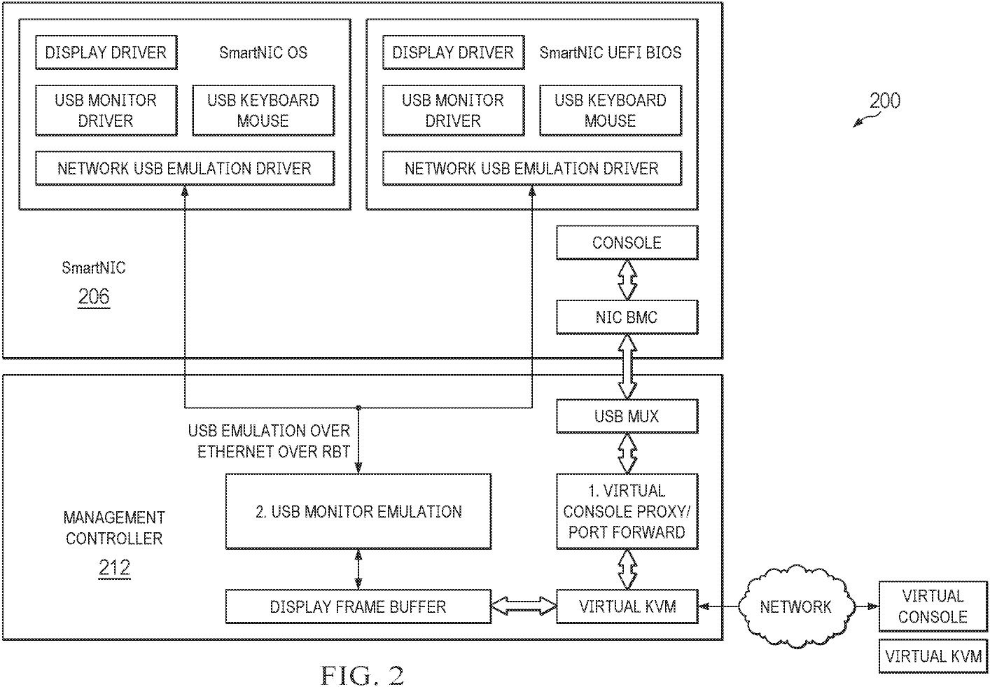

Turning now to FIG. 2, a block diagram is shown of a system 200 in which embodiments of this disclosure may be implemented. System 200 may include a host system (not shown in FIG. 2), a management controller 212, and one or more SmartNICs 206. Management controller 212 may be coupled to SmartNIC 206 via a network controller sideband interface (NC-SI), via USB emulation over Ethernet over reduced media-independent interface (RMII) based transport (RBT), via PCIe vendor-defined message (VDM), via SMBus, or via any other suitable communication channel.

In one embodiment usable for KVM redirection, a management controller embedded in SmartNIC 206 (shown as a NIC BMC in FIG. 2) may be leveraged. Management controller 212 may control a USB multiplexer to connect to the NIC BMC (as well as corresponding NIC BMCs of other SmartNICs, not shown in FIG. 2) and configure the NIC BMC to stream the SmartNIC’s console data. Management controller 212 may then act as a proxy for the NIC BMC and configure network port forwarding to stream the NIC BMC-originated console video frames, redirecting them to a remote virtual console.

In another embodiment for KVM redirection, management controller 212 may provide a virtual USB KVM over Ethernet on an NC-SI pass-through private channel of SmartNIC 206 (e.g., Ethernet over RMII). Emulation of such a USB device for video data may enable system 200 to capture the display frame buffer of the OS and/or pre-OS environment of SmartNIC 206 for virtual console redirection/streaming.

In particular, SmartNIC 206 may identify the virtual monitor interface provided by management controller 212 and push video frames generated by SmartNIC 206 (e.g., by the SmartNIC OS or SmartNIC pre-OS UEFI BIOS) to that interface. In this way, the entire boot process of the SmartNIC from the pre-OS environment through the OS phase may be streamed to management controller 212.

The virtual KVM provided by management controller 212 may be identified as a USB keyboard, a USB monitor for video, and a USB mouse by all connected SmartNICs, which may use them for continuous streaming of the video data generated by the SmartNICs. In one embodiment, management controller 212 may include multiplexing logic to provide KVM functionality to one SmartNIC 206 at any given time. In another embodiment, however, management controller 212 may redirect all of the video frame buffers of SmartNICs 206 simultaneously, and a remote virtual console may then show all of the redirected video screams (e.g., in a split screen configuration). The virtual console may also provide the option of selecting among all of the available consoles/devices for redirection, along with an option to choose the device to redirect (e.g., based on the fully qualified device descriptor (FQDD) of the device). The virtual console may also allow for selection of which SmartNIC 206 should receive keyboard and mouse input.

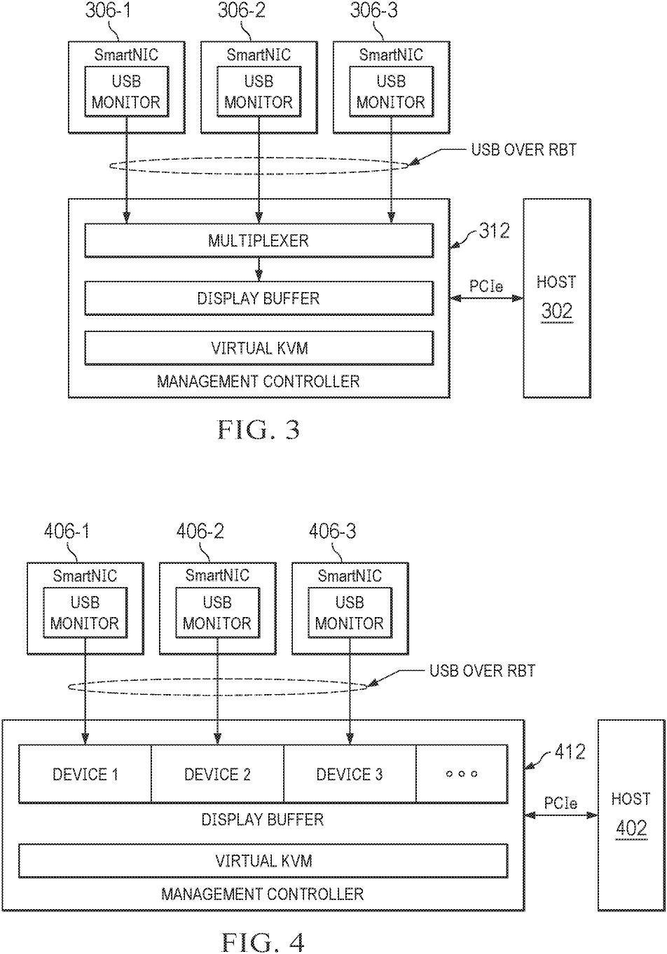

Turning now to FIGS. 3 and 4, embodiments are shown of systems in which multiple SmartNICs have implemented redirected KVM functionality via a management controller. In the example of FIG. 3, SmartNICs 306 are coupled to a multiplexer of management controller 312. The multiplexer may be controlled via host 302 or some other remote console information handling system to select a particular one of SmartNICs 306 for remote viewing and control. The selected SmartNIC 306 may stream video data into a display buffer of management controller 312, which may be accessible via a virtual KVM.

In the example of FIG. 4, SmartNICs 406 may all simultaneously stream video data into separate portions of a display buffer (or separate display buffers) at management controller 412. The video data may then be accessed simultaneously. In one embodiment, a particular SmartNIC 406 may be selected at any given time, such that keyboard/mouse interactions may be sent to the selected one.

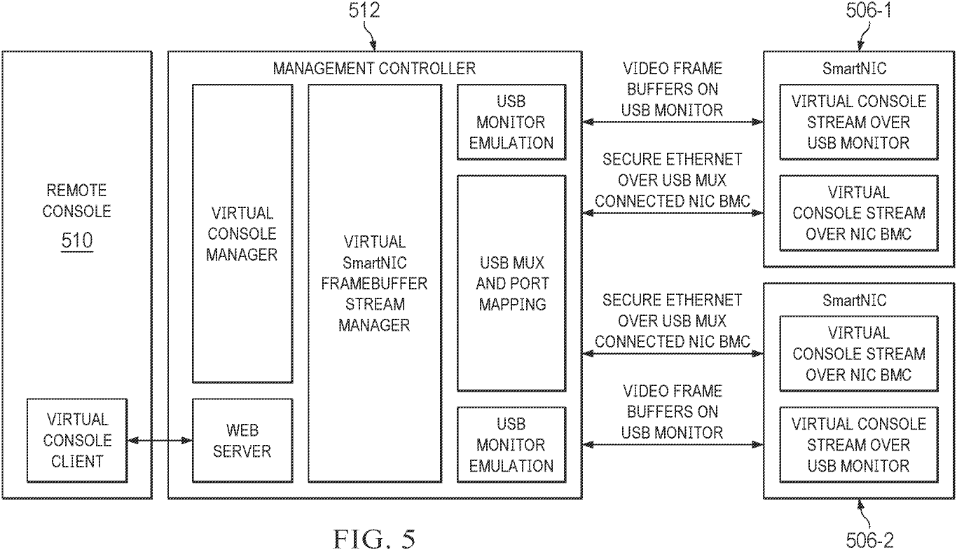

FIG. 5 illustrates yet another embodiment. Management controller 512 is configured to communicate with SmartNICs 506 as shown, providing KVM access to remote console 510. In one embodiment, management controller 512 may implement network port mapping to stream the video frames from SmartNICs 506 and redirect them to remote console 510.

Another embodiment of this disclosure relates to the redirection of serial console data, as opposed to KVM data, to and/or from a SmartNIC. In particular, a SmartNIC serial port may be connected to a management controller serial port (e.g., via a serial multiplexer). In one embodiment, an IPMI serial-over-LAN implementation may be used to redirect the serial console traffic of one or more SmartNICs using standard IPMI commands.

For example, the ipmitool command may be used to select a particular SmartNIC by its FQDD in order to enable and disable the serial redirection for that SmartNIC. The redirected serial console data may include various types of data, such as redirected racadm console data over secure shell (SSH), Redfish data streaming, etc. In various embodiments, the redirected data may be transmitted through any suitable network protocol, such as SSH, HTTP, HTTPS, Remote Management Control Protocol (RMCP), RMCP+, etc.

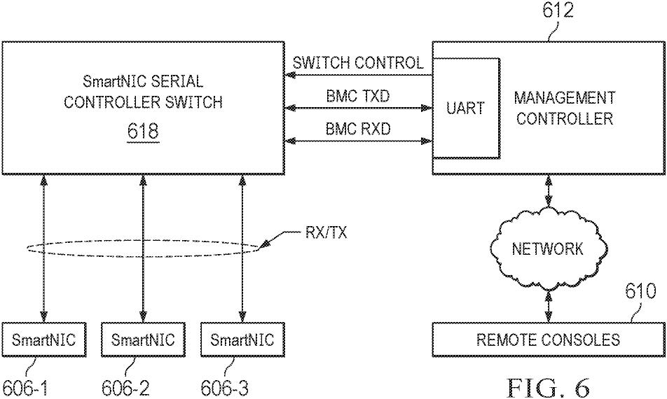

FIG. 6 illustrates an example architecture for implementing serial redirection, in accordance with some embodiments. Management controller 612 includes a universal asynchronous receiver-transmitter (UART) that is communicatively coupled to a SmartNIC serial controller switch 618 via a transmit channel BMC TXD, a receive channel BMC RXD, and a switch control channel. SmartNIC serial controller switch 618 may be implemented via hardware, software, and/or firmware. In some embodiments, it may be internal to management controller 612, while in other embodiments it may be located elsewhere in the system.

Management controller 612 may thus control SmartNIC serial controller switch 618 by instructing it to forward data to and from a particular one of SmartNICs 606 (e.g., selected via FQDD or in any other suitable manner). SmartNIC serial controller switch 618 may then act as a serial pass-through or multiplexer to enable communication between the selected SmartNIC 606 and management controller 612. Management controller 612 itself may then act as a pass-through to enable communication between the selected SmartNIC 606 and one or more remote consoles 610, connected to management controller 612 via a network.

Although various possible advantages with respect to embodiments of this disclosure have been described, one of ordinary skill in the art with the benefit of this disclosure will understand that in any particular embodiment, not all of such advantages may be applicable. In any particular embodiment, some, all, or even none of the listed advantages may apply.

This disclosure encompasses all changes, substitutions, variations, alterations, and modifications to the exemplary embodiments herein that a person having ordinary skill in the art would comprehend. Similarly, where appropriate, the appended claims encompass all changes, substitutions, variations, alterations, and modifications to the exemplary embodiments herein that a person having ordinary skill in the art would comprehend. Moreover, reference in the appended claims to an apparatus or system or a component of an apparatus or system being adapted to, arranged to, capable of, configured to, enabled to, operable to, or operative to perform a particular function encompasses that apparatus, system, or component, whether or not it or that particular function is activated, turned on, or unlocked, as long as that apparatus, system, or component is so adapted, arranged, capable, configured, enabled, operable, or operative.

Unless otherwise specifically noted, articles depicted in the drawings are not necessarily drawn to scale. However, in some embodiments, articles depicted in the drawings may be to scale.

Further, reciting in the appended claims that a structure is “configured to” or “operable to” perform one or more tasks is expressly intended not to invoke 35 U.S.C. § 112(f) for that claim element. Accordingly, none of the claims in this application as filed are intended to be interpreted as having means-plus-function elements. Should Applicant wish to invoke § 112(f) during prosecution, Applicant will recite claim elements using the “means for [performing a function]” construct.

All examples and conditional language recited herein are intended for pedagogical objects to aid the reader in understanding the invention and the concepts contributed by the inventor to furthering the art, and are construed as being without limitation to such specifically recited examples and conditions. Although embodiments of the present inventions have been described in detail, it should be understood that various changes, substitutions, and alterations could be made hereto without departing from the spirit and scope of the disclosure.

What is claimed is:

1. An information handling system comprising:
a management controller configured to provide out-of-band management of the information handling system; and
a network interface controller;
wherein the management controller is configured to:
receive management data from the network interface controller; and
redirect the management data to a remote console.

2. The information handling system of claim 1, wherein the network interface controller is a SmartNIC.

3. The information handling system of claim 1, wherein the remote console is implemented via a host system of the information handling system.

4. The information handling system of claim 1, wherein the management data comprises serial console data.

5. The information handling system of claim 1, wherein the management data comprises graphical data.

6. The information handling system of claim 5, wherein the management controller is further configured to transmit keyboard and mouse input data from the remote console to the network interface controller.

7. The information handling system of claim 5, wherein the management controller is configured to receive the graphical data via an emulated universal serial bus (USB) monitor interface.

8. A method comprising, in an information handling system including a network interface controller and a management controller configured to provide out-of-band management of the information handling system:
the management controller receiving management data from the network interface controller; and
the management controller redirecting the management data to a remote console.

9. The method of claim 8, wherein the network interface controller is a SmartNIC.

10. The method of claim 8, wherein the remote console is implemented via a host system of the information handling system.

11. The method of claim 8, wherein the management data comprises serial console data.

12. The method of claim 8, wherein the management data comprises graphical data.

13. The method of claim 12, wherein the management controller is further configured to transmit keyboard and mouse input data from the remote console to the network interface controller.

14. The method of claim 12, wherein the management controller is configured to receive the graphical data via an emulated universal serial bus (USB) monitor interface.

15. An article of manufacture comprising a non-transitory, computer-readable medium having instructions thereon that are executable by at least one processor of a management controller of an information handling system for:
receiving management data from a network interface controller of the information handling system; and
redirecting the management data to a remote console.

16. The article of claim 15, wherein the network interface controller is a SmartNIC.

17. The article of claim 15, wherein the remote console is implemented via a host system of the information handling system.

18. The article of claim 15, wherein the management data comprises serial console data.

19. The article of claim 15, wherein the management data comprises graphical data.

20. The article of claim 19, wherein the instructions are further executable for transmitting keyboard and mouse input data from the remote console to the network interface controller.
